(19) United States
(12) Patent Application Publication
(10) Pub. No.: US 2005/0138587 A1
(43) Pub. Date: Jun. 23, 2005

(54) Analysis of congestion attributed to component placement in an integrated circuit topology floor-plan

(76) Inventor: Michael C. Naum, Woodstock, CT (US)

Correspondence Address: McDermott, Will & Emery LLP;Attn: David M. Mello, 28 State Street, Boston, MA, 02109, US

(21) Appl. No.: 11/017,107

(22) Filed: Dec. 20, 2004

Related U.S. Application Data
(60) Provisional application No. 60/530,963, filed on Dec. 19, 2003.

(51) Int. Cl. G06F 9/45

(52) U.S. Cl. 716/5; 716/8

(57) ABSTRACT

A system and method for determining cell congestion in an integrated circuit (IC) floor-plan comprising a set of rows configured for placement of components represented as cells, comprises dividing the floor-plan into a plurality of windows, selecting a window from the plurality of windows, the window comprising a subset of rows from the set of rows, for the subset of rows, determining a cell distribution comprising a number of cells in the subset of rows and determining a pin distribution for each cell in the cell distribution and determining a congestion value for the selected window as a function of the cell distribution and pin distribution.

### CROSS REFERENCE TO RELATED APPLICATIONS

This application claims the benefit of priority under 35 U.S.C. §119(e) from co-pending, commonly owned U.S. provisional patent application Ser. No. 60/530,963, entitled SYSTEM FOR AND METHOD OF ANALYZING CONGESTION ATTRIBUTED TO COMPONENT PLACEMENT IN AN IC TOPOLOGY FLOORPLAN, filed Dec. 19, 2003.

### FIELD OF INTEREST

The present disclosure relates generally to the field of electronic design automation (EDA), and more particularly to an improved system for and technique of automated analysis of congestion of an integrated circuit layout.

### BACKGROUND

Designers of integrated circuit layouts use a system, usually in the form of a workstation equipped with design tools, to position the various components of a circuit design within a confined area of a die layout, usually referred to as a “floor-plan”. The tools are designed to make it easier for the designer to create a workable layout so that the integrated circuits can be created using semiconductor fabrication equipment and techniques.

One type of integrated circuit which requires a significant amount of work and planning in designing a workable layout is the Application-Specific Integrated Circuit or ASIC. ASICs are chips that contain an array of hardware logic devices that are configured by a system designer to produce a certain behavior. ASICs have been used for many years as a way of providing a connection or “glue” logic in a single device on a board, but more recently they have been used to provide the logic for an entire board design on a single chip. This type of circuit design is commonly referred to as a “system on a chip”. Even more recently, processors have been added into these designs. Many popular standard CPU architectures such as the “ARM” and “MIPS” are available in hardware description languages or libraries, which allow these processors to be integrated with memory and I/O devices on a single chip to create a custom implementation.

One advantage of this approach is that it provides for a lower overall cost for systems that are produced in high volume. In addition, system quality is better since there are fewer connections between individual devices (or components) on the system board. System speed is also much greater since the external memories are sometimes placed inside the chip, and there are far fewer interconnects needed to connect to other external chips in order to create a specific function.

One problem with such complex ASICs is the ability of the design engineer to determine where on the die to place components such that they are in optimal locations. Typically, a design template for an IC layout provides spaced apart rows, each row being of a standard height and a width that typically extends the width of the die. The components are represented by cells that are placed with respect to the rows. “Standard cells” are cells that are distributed within the rows, the rows being provided as a part of the design layout. Cells that do not fit within the dimensions of the rows are referred to as “macro cells”. The system typically confines the positioning of standard cells so that they are always positioned within a row. Thus, macro cells are typically larger than the standard cells, both in height and width, so do not lend themselves to automatic placement with respect to a row. Manual placement is often required. However, commonly owned patent application Ser. No. 10/932,759 entitled AUTOMATIC SYSTEM FOR AND METHOD OF MACRO CELL PLACEMENT WITHIN AN INTEGRATED CIRCUIT LAYOUT does provide a system and method for automated placement of macro cells.

FIG. 1 depicts a prior art methodology utilized to bring the physical design process of an integrated circuit up to what is commonly known as “a timing closed placement”. As shown in FIG. 1, the process begins at step 10 with the design of an IC to meet its intended functions. Step 10 comprises modeling functions in typical IC components that consist of some combination of standard cells and macro cells. Next, a floor-planning stage is conducted in step 12, which consists of defining the size of the integrated circuit, developing the I/O locations, creating groups and regions, manually placing macro cells, and, finally, determining overall die utilization, as is shown in sub-step 12A.

The floor-planning stage 12, is performed by a module commonly called a “planner”, and is generally considered the most important stage of the physical design process. Errors in this stage will manifest themselves as timing violations, placement congestion, and routing congestion later in the physical design process. An incorrect placement of either a macro cell or an I/O cell will spatially constrain the remaining standard cells, placed during the placement step 14 depicted in FIG. 1, into sub-optimal locations. The placement step 14 is conducted by a module commonly referred to as a “placer”. The placement step 14 consists of placing standard cells (depicted in step 14A), given the manual placement of the macro cells in step 12A. Following cell placement in step 14, a post placement optimization stage, in step 16, is performed, followed by the post placement analysis stage, in step 18.

FIG. 2A is a non-scale simplified representation of-a floor-plan of an integrated circuit 200, which comprises a set of rows 52. Using a typical approach, such as that of FIG. 1, the system confines the positioning of standard cells (represented as “C” generally) so that they are always positioned within a row, e.g., rows 52A and row 52B. Current design tools allow the designer to automatically position standard cells throughout the layout by inserting cells C in rows based upon certain cost functions. This can lead to sub-optimal placement of the cells. Each of the cells includes two or more pins, representing inputs and outputs of the devices that need to be connected to pins of other components within the layout. Cells with a relatively high number of pins can significantly increase the density in the areas surrounding such cells. However, the current tools do not consider the contribution of the pins to the density. As a result current tolls can densely populate certain areas of the layout, while other areas may be sparsely populated. The densely populated areas can lead to a condition called “congestion”, largely due to the many connections that need to be made among the various pins of the cells in those densely populated areas.

Accordingly, current design tools usually provide a tool to analyze the congestion of each row, for the entire floor-plan layout. Such tools generate a graphical image representing the degree to which a given row is occupied by cells, as an indication of congestion. FIG. 2B shows and example, where such congestion is represented in a line (or bar) graph 250 that is generally one dimensional (“1-D”). That is, to generate bar graph 250, the number of cells is counted in a given row. Region 252 indicates the percentage of the row occupied by cells (or the number of cells) and region 254 represents the percentage of the row that is empty.

However, this often is insufficient information to the designer as to the degree of congestion that a particular area of the layout might contain. For example, the distribution of the cells of the row is not revealed by the line graph. Cells might be crowded in one location along the row, or might be evenly distributed along the row. There is no way to know from the bar graph 250. Further, the functionality and nature of cells can differ, with some cells requiring more pins than others. The size of a cell (the amount of space it occupies in a row) is not necessarily correlated to the number of pins that are provided on the cell. The higher number of the pins, the more lines and connections that are required. These lines and connections contribute to the congestion.

### SUMMARY OF INVENTION

In accordance with one aspect of the present invention, provided is a method of determining congestion in an integrated circuit (IC) floor-plan comprising a set of rows configured for placement of components represented as cells. The method comprises the steps of dividing the floor-plan into a plurality of windows and selecting a window from the plurality of windows, the window comprising a subset of rows from the set of rows. The method further includes, for the subset of rows, determining a cell distribution comprising a number of cells in the subset of rows and determining a pin distribution for each cell in the cell distribution, and determining a congestion value for the selected window as a function of the cell distribution and pin distribution.

In accordance with another aspect of the present invention, provided is a system for determining congestion in an integrated circuit (IC) floor-plan comprising a set of rows configured for placement of components represented as cells. The system comprises means for dividing the floor-plan into a plurality of windows and means for selecting a window from the plurality of windows, the window comprising a subset of rows from the set of rows. The system also includes, for the subset of rows, means for determining a cell distribution comprising a number of cells in the subset of rows and for determining a pin distribution for each cell in the cell distribution, and means for determining a congestion value for the selected window as a function of the cell distribution and pin distribution.

In accordance with another aspect of the present invention, provided is a computer readable media embodying a program of instructions executable by a processor to perform a method of determining congestion in an integrated circuit (IC) floor-plan comprising a set of rows configured for placement of components represented as cells. The method comprises dividing the floor-plan into a plurality of windows and selecting a window from the plurality of windows, the window comprising a subset of rows from the set of rows. The method also includes, for the subset of rows, determining a cell distribution comprising a number of cells in the subset of rows and determining a pin distribution for each cell in the cell distribution, and determining a congestion value for the selected window as a function of the cell distribution and pin distribution.

Any of the foregoing may include determining a congestion value for each of the windows and graphically representing each of the windows and the congestion value for each of the windows. Additionally, the IC may be an ASIC or any other type of IC known in the art or subsequently developed that has similar congestion concerns regarding layout components, connections and lines.

### BRIEF DESCRIPTION OF THE DRAWINGS

The drawing figures depict preferred embodiments by way of example, not by way of limitations. In the figures, like reference numerals refer to the same or similar elements.

FIG. 1 is a flowchart of a prior art methodology utilized to design an integrated circuit layout.

FIG. 2A is a non-scale simplified view of an integrated circuit “floor-plan” illustrating the problem with the prior art methodology of FIG. 1.

FIG. 2B is view of a bar graph that may be presented to represent cell congestion within a single row of a floor-plan, by typical tools that may be incorporated in the prior art methodology of FIG. 1.

FIG. 3 is a flow chart of methodology for analyzing the congestion of cells in a floor-plan of an integrated circuit layout.

FIG. 4 is a non-scale view of a floor-plan divided in accordance with aspects of the present invention.

FIG. 5 is a non-scale simplified view of an individual window taken from the divided floor-plan of FIG. 4.

FIG. 6 is a block diagram of a system for carrying out the methodology of FIG. 3.

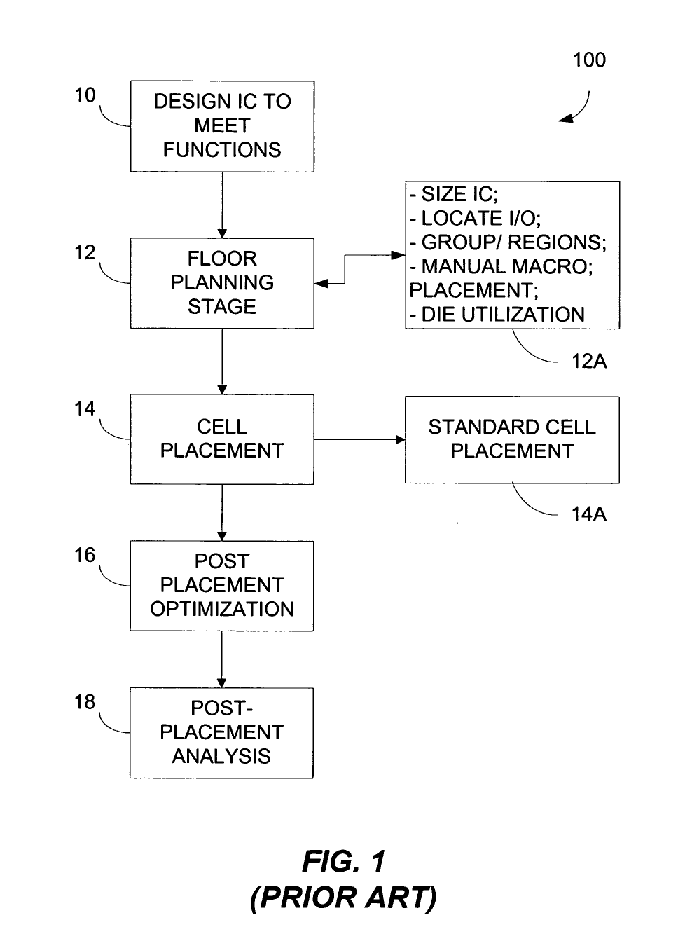

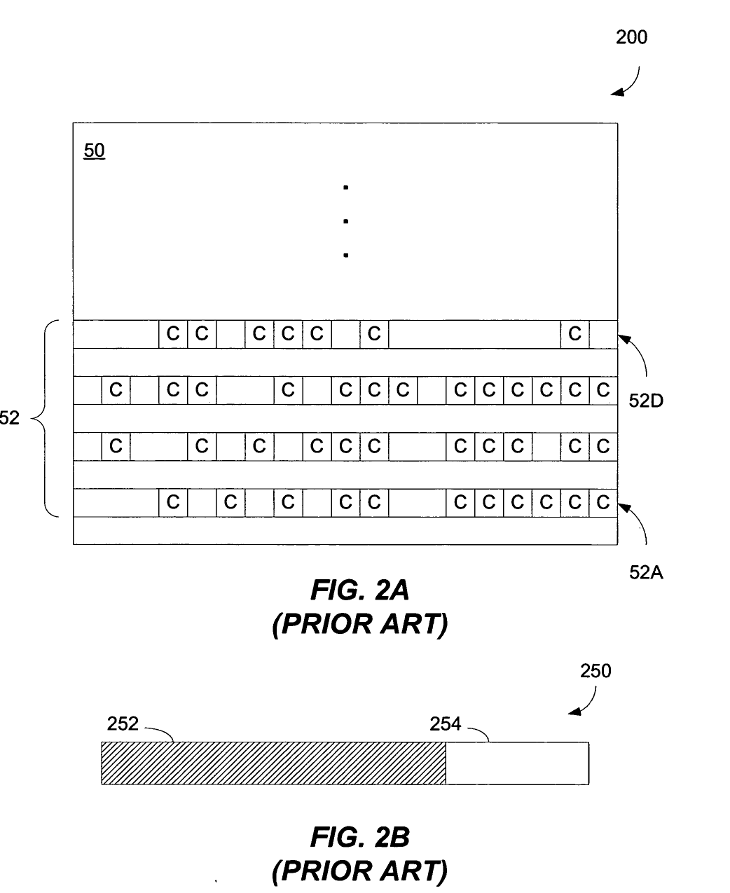

### DETAILED DESCRIPTION OF PREFERRED EMBODIMENT

In accordance with aspects of the illustrative embodiment, an approach to determining the congestion within an integrated circuit (IC) layout floor-plan is to divide the floor-plan into a plurality of windows and then analyze the congestion within each window. Part of the analysis of each window is to analyze not only the distribution of cells within a selected window, but also the pins. Pins imply connections and, thus, lines, so they can significantly effect congestion. Therefore, analysis of congestion can be greatly improved by a design tool or modification of current design tools that enable analysis of cell distribution and pins provided by the cells in each row of a window.

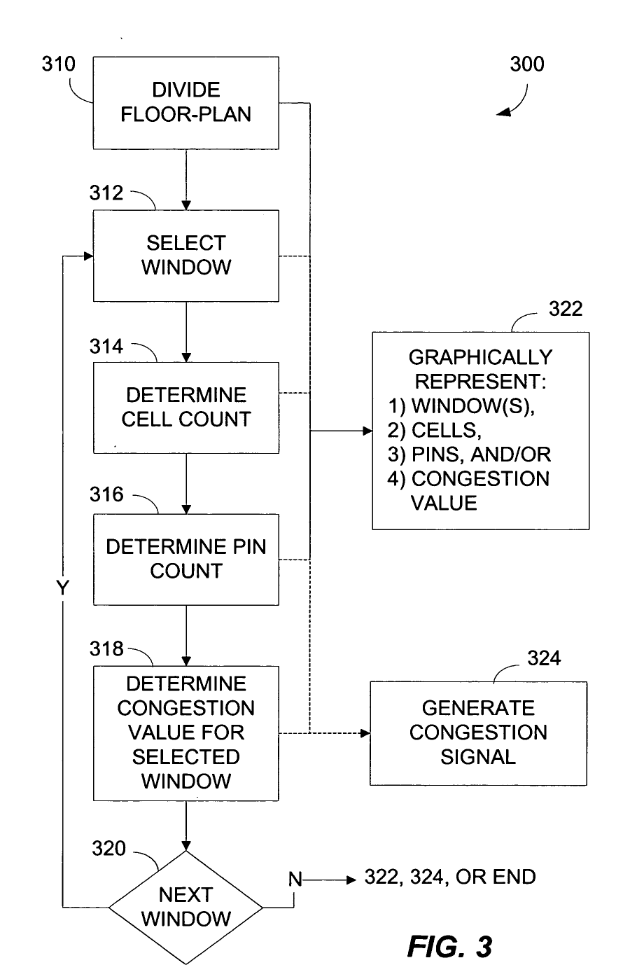

FIG. 3 is flowchart 300 providing an illustrative method of analyzing congestion. In FIG. 3 certain optional output steps are depicted with dashed lines (i.e., steps 322 and 324). When a designer (or user) wishes to analyze congestion, the layout is initially divided into a number of sub-areas or “windows”, as in step 310, and then analyzed on a row-by-row basis. The number of windows will depend, for example, on the size and the complexity of the IC, how detailed the analysis is desired to be, and the overall total number of cells to be placed.

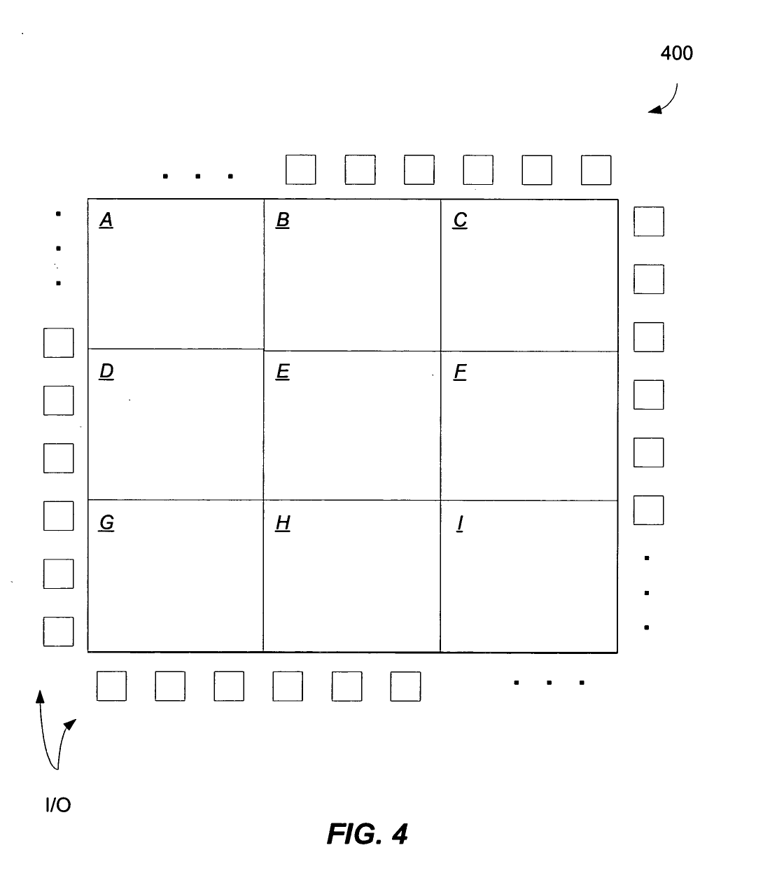

As an example, the floor-plan could be represented in two dimensions—such as a rectangle or square. Accordingly, each window could be a smaller rectangle or square within the larger floor-plan. Each window may be the same size and shape, but in some embodiments, the windows could be different sizes and shapes. When the windows are the same size and shape, the number of windows that the floor-plan is to be divided into may be predetermined, or it may determined by a user's input (e.g., number of windows=x, where x can equal any positive integer value). As one possible example, FIG. 4 shows a simplified view of an IC 400. Here a plurality of peripheral input/ output (I/O) pins or connectors are shown. These provide a means for the IC 400 to communicate with devices external to it. The floor-plan has been divided into nine windows having approximately the same dimensions. The windows are designated as windows A-I Optionally, the IC 400 could be graphically presented via a graphical interface (e.g., computer monitor, display screen or the like), as is shown in optional step 322. In such a case, the display could show the floor-plan divided into windows. A representation of IC 400 with the windows could also be stored, printed, or communicated to another device or process.

In alternative embodiments, the number of windows may be derived from other information. For example, a threshold congestion value (e.g., y) may be provided. As will be discussed in greater detail below, the congestion value is an indicia or representation of the congestion of a window. The threshold congestion value could set such that at least one window must have a congestion value that is greater than or equal to y. In such a case, the minimum size and shape window within the floor-plan having a congestion value greater than or equal to y can be chosen as the size and shape for all windows. As an example, this could be accomplished by iterating through values of x, i.e., number of windows, until the smallest window size for which the threshold value y is achieved is found, which would also yield the largest number of windows x for the given threshold y. If there is never determined a window size for which the congestion value is greater than or equal to the threshold value of y then congestion for the floor-plan may not be of concern and the analysis could be terminated. In which a new threshold value could be selected.

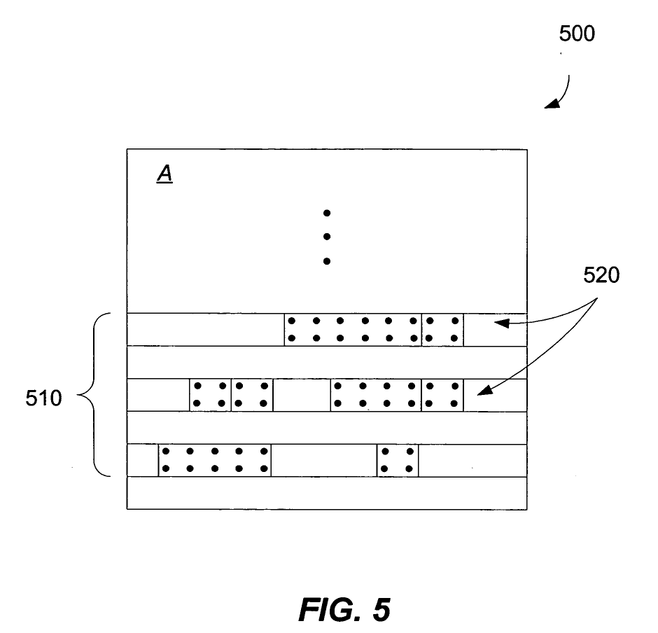

Returning to FIG. 3, with the floor-plan divided into a plurality of windows, the analysis is done on a window-by-window basis. In step 312 of flowchart 300 a window is selected for analysis. In FIG. 5, window A has been selected and a view 500 of window A is shown. The view 500 of window A is a simplified version of a portion of a floor-plan for IC 400. At least some of the rows included in IC 400 are found in window A, and thus are represented as rows 510 in FIG. 5. In this embodiment, rows 510, because of the manner in which the IC 400 was divided (see FIG. 4), are portions of rows that would continue into adjacent window B. But in other embodiments, with a different IC or if the IC were divided differently complete rows could be included in a window.

As with IC 400 in FIG. 4, optionally, the view 500 could be graphically presented via a graphical interface (e.g., computer monitor, display screen or the like), as is shown in optional step 322. In such a case, the display could show, within the window, the distribution of cells and pins. View 500 could also be stored, printed, or communicated to another device or process.

Again returning to FIG. 3, for the selected window a cell distribution, in step 314 and a pin distribution, in step 316, could be determined. In FIG. 5, within rows 510 are disposed various cells 520, which represent any number of components known in the art. The distribution of the cells 520 within the rows 510 is shown. In addition to determining the cells spatial distribution, an indication is given as to actual pin distribution of each cell, which is a more accurate measure of possible congestion. Further, the number of pins in adjacent rows can be compared.

From cell distribution and pin distribution information, a congestion value for the selected window could be determined in step 318. For example, the congestion value could be determined from the number of cells and the number of pins and their spacing in each row, and with respect to adjacent rows. The number of pins for a given cell will generally imply a certain size of the cell—so the actual physical dimensions of each cell are not necessary to determine a congestion value. Threshold values or ranges of congestion can be established and the cell distribution and pin distribution for a given window and be compared to those threshold values to determine the congestion value. For example, the cell and pin distributions allow an assessment of utilization of a row or of a window. The congestion value could be a representation of that utilization. If the determined utilization falls within a predetermined range of values, e.g., 90%-100%, then the congestion value could be HIGH or the color RED. Each window may have its own congestion value.

Once the congestion value is determined it can be stored, printed, displayed or used by other processes. In step 324, a congestion signal could be generated that includes indicia of one or more congestion values or that communicates to other processes that one or more congestion values has been stored and are available for use.

A test could be included as step 320 of FIG. 3 that determines if there are other windows for which congestion analysis is to be performed and, if so, returns to step 312 where another window is selected. Otherwise, the process could go from step 320 to step 322 or 324, as discussed above, or could end.

As mentioned, the congestion value is an indicia of the congestion (or density) within a window, which can be presented graphically in any number of forms. For example, the window could be displayed and the congestion value could be represented as a color of the window. The congestion value could take any of a number forms, wherein there is a known meaning associated with each possible congestion value. The congestion value could be represented as a word, symbol, number or character from a set of predetermined words, symbols, numbers or characters, where there is known meaning relative to congestion associated with each of the words, symbols, numbers or characters. Any of these possible representations of congestion value could be graphically displayed, alone or in combination, in relation to the corresponding window. Congestion values could also be represented with any known type of graphing or charting technique, e.g., bar charts or graphs. Multiple (or all) windows for an IC could be graphically portrayed, with the congestion value for each window also represented.

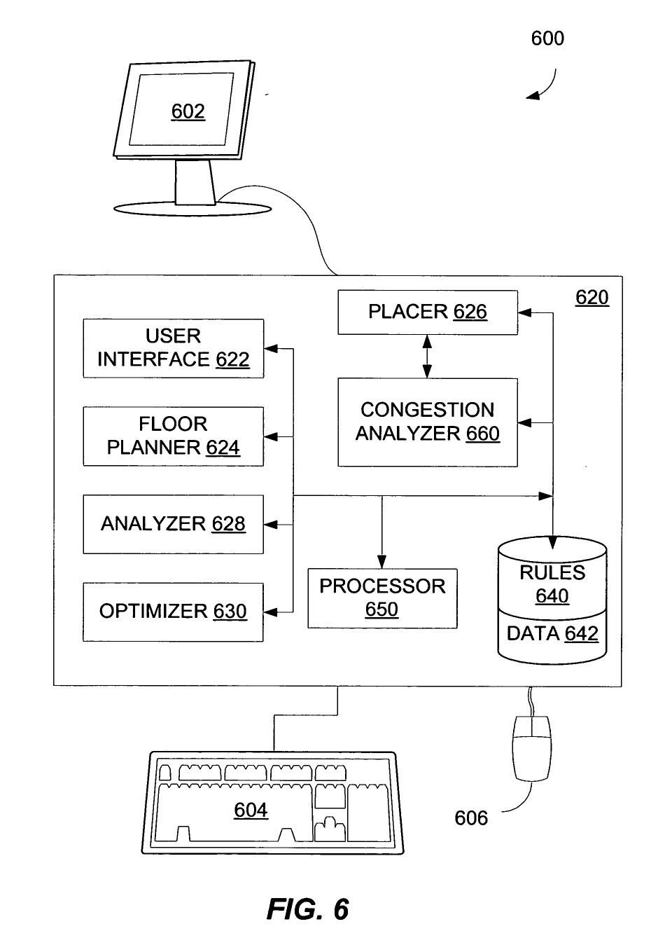

It should be appreciated that the entire process described above, including the method 300 of FIG. 3, can be carried out on a workstation 600 comprising a visual display 602 and one or more input devices, such as a keyboard 604 and mouse 606, such as shown in FIG. 6. In such a case, the workstation can execute an IC design program 620, which may be comprised of functions implemented in hardware, software, firmware or some combination thereof. The IC design program 620 may include, or have access to, a set of rules 640 used, for example, for laying out row dimensions, defining standard cells (e.g., inverters) functionally and physically and imposing other typical constraints. The IC design program 620 may similarly include or have access to a database for storing data related to a particular layout. For example, a user could input a design via the user interface module 622 (and display 602, keyboard 604 and mouse 606), which may then be stored in database 642.

A typical floor planner module 624 may then be used for defining the size of the integrated circuit, developing the I/O locations, creating groups and regions and determining overall die utilization, as is shown. Depending on the floor-planner module 624 it may or may not accommodate placement of macro cells, as well as standard cells. Again, depending on the embodiment, the cell placer module 626 may be configured for performing both standard cell placement and macro cell placement.

Also included may be post placement analyzer 628 and optimizer 630, which analyze the layout and make adjustments to make the IC generally more efficient. These modules, generally assume that the IC is functionally correct, but optimization can better use the space and perhaps shorten transmission paths within the chips, making the IC run faster. Generally, such post placement analyzers and optimizers are known, but may use the cell placer module 626 to adjust the layout of the IC, if necessary.

In this embodiment, a congestion analyzer 660 may also be included, either as a module within the IC design program 320 (as is shown), an addition or modification to an existing module or as a standalone tool that accesses floor-plan data in database 642 to analyze the congestion of the floor-plan produced by the other IC design modules. In either case, congestion analyzer 660 embodies code to carry out the steps of FIG. 3 discussed above. The congestion analyzer 660 may generate a congestion signal, including a representation of one or more congestion values, or indicating that the congestion value has been stored and is available for use by other modules. Either way, the congestion value may be used as feedback to adjust or optimize the design—leading to a new floor-plan that reduces or eliminates any congestion found by the congestion analyzer 660. The congestion signal or value could be used by used by one or more of the floor planner 624, placer 626, analyzer 628, or optimizer 630 in performing their respective functions discussed above.

While the logic and data of the system of FIG. 6 have been shown to be embodied in a single workstation, those skilled in the art will appreciate that various elements may be shared across several workstations, personal computers or other devices that can be either locally or remotely accessed. For example, some or all of the data, rules, or functional modules may be resident on one or more remote servers, accessible via a network, such as the Internet or World Wide Web. Also, while the description has been provided in connection with ASICs, it should also be understood that the improvements of this disclosure can be applied to the design of any integrated circuit.

In any of the foregoing embodiments, or other similar embodiments, the result is a tool for analyzing congestion that is more accurate than the 1-D analysis tools of the prior art.

While the foregoing has described what are considered to be the best mode and/or other preferred embodiments, it is understood that various modifications may be made therein and that the invention or inventions may be implemented in various forms and embodiments, and that they may be applied in numerous applications, only some of which have been described herein. As used herein, the terms “includes” and “including” mean without limitation. It is intended by the following claims to claim any and all modifications and variations that fall within the true scope of the inventive concepts.

1. A method of determining congestion in an integrated circuit (IC) floor-plan comprising a set of rows configured for placement of components represented as cells, the method comprising the steps of:
A. dividing the floor-plan into a plurality of windows;
B. selecting a window from the plurality of windows, the selected window comprising a subset of rows from the set of rows;
C. for the subset of rows, determining a cell distribution comprising a number of cells in the subset of rows and determining a pin distribution for each cell in said cell distribution; and
D. determining a congestion value for said selected window as a function of the cell distribution and pin distribution.

2. The method of claim 1, further comprising a step of:
E. graphically representing the plurality of windows.

3. The method of claim 1, further comprising a step of:
E. graphically representing the congestion value.

4. The method of claim 1, further comprising a step of:
E. graphically representing the selected window and graphically representing the congestion value as a color of the selected window.

5. The method of claim 1, further comprising the step of:
E. determining a congestion value for each of said plurality of windows; and
F. graphically representing each of said plurality of windows and graphically representing the congestion value of each of said plurality of windows.

6. The method of claim 5, wherein step F comprises graphically representing the congestion value of each of the plurality of windows as a color.

7. The method of claim 1, further comprising the step of:
E. generating a congestion signal representing the congestion value.

8. The method of claim 7, further comprising transmitting the congestion signal.

9. The method of claim 1 wherein the IC is an application-specific IC (ASIC).

10. A system for determining congestion in an integrated circuit (IC) floor-plan comprising a set of rows configured for placement of components represented as cells, the system comprising:
A. means for dividing the floor-plan into a plurality of windows;
B. means for selecting a window from the plurality of windows, the selected window comprising a subset of rows from the set of rows;
C. for the subset of rows, means for determining a cell distribution comprising a number of cells in the subset of rows and determining a pin distribution for each cell in said cell distribution; and
D. means for determining a congestion value for said selected window as a function of the cell distribution and pin distribution.

11. The system of claim 10, further comprising:
E. means for graphically representing the plurality of windows.

12. The system of claim 10, further comprising:
E. means for graphically representing the congestion value.

13. The system of claim 10, further comprising:
E. means for graphically representing the selected window and graphically representing the congestion value as a color of the selected window.

14. The system of claim 10, further comprises:
E. means for determining a congestion value for each of said plurality of windows; and
F. means for graphically representing each of said plurality of windows and graphically representing the congestion value of each of said plurality of windows.

15. The system of claim 14, further comprising in part F means for graphically representing the congestion value of each of the plurality of windows as a color.

16. The system of claim 10, further comprising:
E. means for generating a congestion signal representing the congestion value.

17. The system of claim 16, further comprising means for transmitting the congestion signal.

18. The system of claim 10, wherein the IC is an application-specific IC (ASIC).

19. Computer readable media embodying a program of instructions executable by a processor to perform a method of determining congestion in an integrated circuit (IC) floor-plan comprising a set of rows configured for placement of components represented as cells, the method comprising the steps of:
A. dividing the floor-plan into a plurality of windows;
B. selecting a window from the plurality of windows, the selected window comprising a subset of rows from the set of rows;
C. for the subset of rows, determining a cell distribution comprising a number of cells in the subset of rows and determining a pin distribution for each cell in said cell distribution; and
D. determining a congestion value for said selected window as a function of the cell distribution and pin distribution.

20. The computer readable medium of claim 19, the method of claim 1, further comprising a step of:
E. graphically representing the plurality of windows.

21. The computer readable medium of claim 19, the method further comprising a step of:
E. graphically representing the congestion value.

22. The computer readable medium of claim 19, the method further comprising a step of:
E. graphically representing the selected window and graphically representing the congestion value as a color of the selected window.

23. The computer readable medium of claim 19, the method further comprising the step of:
E. determining a congestion value for each of said plurality of windows; and
F. graphically representing each of said plurality of windows and graphically representing the congestion value of each of said plurality of windows.

24. The computer readable medium of claim 19, wherein the method step F comprises graphically representing the congestion value of each of the plurality of windows as a color.

25. The computer readable medium of claim 19, the method further comprising the step of:
E. generating a congestion signal representing the congestion value.

26. The computer readable medium of claim 25, the method further comprising transmitting the congestion signal.

27. The computer readable medium of claim 19, wherein the IC is an application-specific IC (ASIC).
